(19) United States
(12) Patent Application Publication
(10) Pub. No.: US 2025/0370431 A1
(43) Pub. Date: Dec. 4, 2025

(54) Method, System, and Computer Program Product for Determining Mixing Batch Quality

(71) Applicant: Vitro Flat Glass LLC, Cheswick, PA (US)

(72) Inventors: Wei Xu, Cheswick, PA (US); Alan Dum, Pittsburgh, PA (US); Carl Wilson, Pittsburgh, PA (US)

(21) Appl. No.: 19/224,203

(22) Filed: May 30, 2025

Related U.S. Application Data
(60) Provisional application No. 63/656,011, filed on Jun. 4, 2024.

(51) Int. Cl. G05B 19/4155

(52) U.S. Cl. CPC G05B 19/4155; G05B 2219/45009

(57) ABSTRACT

A method, system, and computer program for determining a ratio of components within a mixture by receiving image data associated with an image of a mixture of cullet and glass batch material, determining the temperature of the mixture from the image data of the mixture within a region of interest, determining a ratio of cullet to glass batch material in the mixture based on the temperature of the mixture, and causing an action based on the ratio of cullet to glass batch material in the mixture.

### CROSS-REFERENCE TO RELATED APPLICATIONS

This application claims priority to and the benefit of U.S. Provisional Patent Application No. 63/656,011 filed on Jun. 4, 2024, the complete disclosure of which is hereby incorporated by reference in its entirety.

### BACKGROUND OF THE INVENTION

### Field of the Invention

This invention relates to a method, system, and computer program product for determining mixing batch quality, as well as making the mixing batch thereof. In particular, this invention relates to a method, system, and computer program product for determining a ratio between cullet and glass batch material of a mixture.

### Description of Related Art

Glass may be produced by heating a batch. The batch may include sand, soda ash, limestone, alumina, dolomite, salt cake, a carbon source (e.g. coal), etc. At times, the batch is combined with cullet. In order to produce a desirable glass product, it is important to control the ratio of materials in the batch (including the cullet). Depending on the amount of such material used to form glass, many properties of glass may differ, such as optical properties and strength of the glass.

Currently, the ratio of the batch to cullet is determined based on premixed weights. For example, if a 30% cullet ratio is needed, the current process may weigh 30 lb of cullet and 70 lb of batch. Then, the two weighed cullet and batch material are mixed to form a mixture. However, the current mixing process does not allow real-time determination of the ratio of the mixture. In other words, there is no way to determine whether the cullet and the batch material are well mixed in the mixture. Therefore, under the current process, it is possible for the cullet and the batch material in the mixture to be completely separated. Accordingly, there is a need for determining a quality, such as the ratio between the glass batch material and cullet, for producing glass.

### SUMMARY OF THE INVENTION

This present invention relates to a computer-implemented method of determining a ratio of components within a mixture, comprising: receiving with at least one processor image data associated with an image of a mixture of cullet and glass batch material, determining with at least one processor the temperature of the mixture from the image data of the mixture within a region of interest, determining with at least one processor a ratio of cullet to glass batch material in the mixture based on the temperature of the mixture, and causing with at least one processor an action based on the ratio of cullet to glass batch material in the mixture.

The present invention also relates to a system comprising at least one processor programmed or configured to receive image data associated with an image of a mixture of cullet and glass batch material, determine the temperature of the mixture from the image data of the mixture within a region of interest, determine a ratio of cullet to glass batch material in the mixture based on the temperature of the mixture, and cause an action based on the ratio of cullet to glass batch material in the mixture.

The present invention also may relate to a computer program product comprising at least one non-transitory computer-readable medium including program instructions that, when executed by at least one processor, cause the at least one processor to receive image data associated with an image of a mixture of cullet and glass batch material, determine the temperature of the mixture from the image data of the mixture within a region of interest, determine a ratio of cullet to glass batch material in the mixture based on the temperature of the mixture, and cause an action based on the ratio of cullet to glass batch material in the mixture.

The present invention may relate to determining a desired temperature of the mixture, wherein determining the desired temperature of the mixture comprises: receiving temperature data of the cullet, receiving temperature data of the glass batch material, and determining the desired temperature based on the temperature data of the cullet, the temperature data of the glass batch material, and a desired ratio of the cullet to glass batch material in the mixture. The temperature of the cullet and the temperature of the glass batch material may differ.

### BRIEF DESCRIPTION OF THE DRAWINGS

The invention will be described with reference to the following drawing figures wherein like reference numbers identify the parts throughout, according to some non-limiting embodiments or aspects.

FIG. 1 shows a system for manufacturing of a mixture, wherein the mixture comprises glass batch material and cullet, according to some non-limiting embodiments or aspects;

FIG. 2 shows a schematic diagram of a system for determining quality of a mixture, according to some non-limiting embodiments or aspects;

FIG. 3 shows a step diagram of a method for determining quality of a mixture, according to some non-limiting embodiments or aspects;

FIG. 4 shows a step diagram of a method for determining quality of a mixture, according to some non-limiting embodiments or aspects;

FIGS. 5 and 6 show a step diagram of a method for calibrating and processing a model for determining quality of a mixture, according to some non-limiting embodiments or aspects; and

FIG. 7 shows a diagram of components of one or more devices and/or one or more systems of systems of FIGS. 1-6, according to some non-limiting embodiments or aspects.

### DESCRIPTION OF THE INVENTION

The term “includes” is synonymous with “comprises”.

As used herein, the articles “a” and “an” are intended to include one or more items and may be used interchangeably with “one or more” and “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some non-limiting embodiments, a message may refer to a network packet (e.g., a data packet and/or the like) that includes data.

As used herein, the term “computing device” may refer to one or more electronic devices configured to process data. A computing device may, in some examples, include the necessary components to receive, process, and output data, such as one or more displays, processors, memory, input devices, network interfaces, and/or the like. The computing device may be a mobile device. As an example, a mobile device may include a cellular phone (e.g., a smartphone or standard cellular phone), a portable computer, a wearable device (e.g., watches, glasses, lenses, clothing, and/or the like), a PDA, and/or other like devices. The computing device may be a non-mobile device, such as a desktop computer. An “interface” refers to a generated display, such as one or more graphical user interfaces (GUIs) with which a user may interact, either directly or indirectly (e.g., through a keyboard, mouse, etc.).

As used herein, the term “server” may refer to or include one or more computing devices that are operated by or facilitate communication and processing for multiple parties in a network environment, such as the internet, although it will be appreciated that communication may be facilitated over one or more public or private network environments and that various other arrangements are possible. Further, multiple computing devices (e.g., servers, mobile devices, etc.) directly or indirectly communicating in the network environment may constitute a “system.” Reference to “a server,” “the server,” “at least one processor,” or “the at least one processor,” or the like, as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “system” may refer to one or more computing devices or combinations of computing devices such as, but not limited to, processors, servers, client devices, software applications, and/or other like components.

The present invention is also directed to the following clauses.

Clause 1: A computer-implemented method of determining a ratio of components within a mixture, comprising: receiving with at least one processor image data associated with an image of a mixture of cullet and glass batch material; determining with at least one processor the temperature of the mixture from the image data of the mixture within a region of interest; determining with at least one processor a ratio of cullet to glass batch material in the mixture based on the temperature of the mixture; and causing with at least one processor an action based on the ratio of cullet to glass batch material in the mixture.

Clause 2: The computer implemented method of clause 1, further comprising: determining the region of interest within the image data, wherein the region of interest comprises an area of the mixture in the image data.

Clause 3: The computer implemented method of clause 1 or 2, further comprising: determining an average ratio of cullet to glass batch material based on a plurality of image data associated with a plurality of images of the of the mixture.

Clause 4: The computer implemented method of any of clauses 1-3, further comprising: determining a desired temperature of the mixture, wherein determining the desired temperature of the mixture comprises: receiving temperature data of the cullet; receiving temperature data of the glass batch material; and determining the desired temperature based on the temperature data of the cullet, the temperature data of the glass batch material, and a desired ratio of the cullet to glass batch material in the mixture.

Clause 5: The computer implemented method of any of clauses 1-4, wherein the action comprises: causing an increase in an amount of the cullet introduced into the mixture, causing a decrease in the amount of cullet introduced into the mixture, and causing no change in the amount of the cullet introduced into the mixture.

Clause 6: The computer implemented method of any of clauses 1-5, wherein causing the increase in the amount of cullet introduced is in response to determining that the ratio of cullet to glass batch material is less than a desired ratio of cullet to glass batch material, and wherein causing the decrease in the amount of cullet introduced is in response to determining that the ratio of cullet to glass batch material is more than the desired ratio of cullet to glass batch material.

Clause 7: The computer implemented method of any of clauses 1-6, wherein the action comprises causing a speed change of a conveyer, causing a change in operation of a mixing wheel, causing a change in a timing of introducing the cullet into the mixture, or causing a change in a rate of introducing of the cullet into the mixture.

Clause 8: The computer implemented method of any of clauses 1-7, wherein temperature of the cullet and temperature of the glass batch material differ.

Clause 9: A system comprising at least one processor programmed or configured to: receiving image data associated with an image of a mixture of cullet and glass batch material; determine the temperature of the mixture from the image data of the mixture within a region of interest; determine a ratio of cullet to glass batch material in the mixture based on the temperature of the mixture; and cause an action based on the ratio of cullet to glass batch material in the mixture.

Clause 10: The system of clause 9, the at least one processor further programmed or configured to: determine the region of interest within the image data, wherein the region of interest comprises an area of the mixture in the image data.

Clause 11: The system of clause 9 or 10, the at least one processor further programmed or configured to: determine an average ratio of cullet to glass batch material based on a plurality of image data associated with a plurality of images of the of the mixture.

Clause 12: The system of any of clauses 9-11, the at least one processor further programmed or configured to: determine a desired temperature of the mixture, wherein determining the desired temperature of the mixture comprises: receiving temperature data of the cullet; receiving temperature data of the glass batch material; and determining the desired temperature based on the temperature data of the cullet, the temperature data of the glass batch material, and a desired ratio of the cullet to glass batch material in the mixture.

Clause 13: The system of any of clauses 9-12, wherein the action comprises: causing an increase in an amount of the cullet introduced into the mixture, causing a decrease in the amount of cullet introduced into the mixture, and causing no change in the amount of the cullet introduced into the mixture.

Clause 14: The system of any of clauses 9-13, wherein causing the increase in the amount of cullet introduced is in response to determining that the ratio of cullet to glass batch material is less than a desired ratio of cullet to glass batch material, and wherein causing the decrease in the amount of cullet introduced is in response to determining that the ratio of cullet to glass batch material is more than the desired ratio of cullet to glass batch material.

Clause 15: The system of any of clauses 9-14, wherein the action comprises causing a speed change of a conveyer, causing a change in operation of a mixing wheel, causing a change in a timing of introducing the cullet into the mixture, or causing a change in a rate of introducing of the cullet into the mixture.

Clause 16: The system of any of clauses 9-15, wherein temperature of the cullet and temperature of the glass batch material differ.

Clause 17: A computer program product comprising at least one non-transitory computer-readable medium including program instructions that, when executed by at least one processor, cause the at least one processor to: receiving image data associated with an image of a mixture of cullet and glass batch material; determine the temperature of the mixture from the image data of the mixture within a region of interest; determine a ratio of cullet to glass batch material in the mixture based on the temperature of the mixture; and cause an action based on the ratio of cullet to glass batch material in the mixture.

Clause 18: The computer program product of clause 17, further causing the at least one processor to: determine the region of interest within the image data, wherein the region of interest comprises an area of the mixture in the image data.

Clause 19: The computer program product of clause 17 or 18, further causing the at least one processor to: determine an average ratio of cullet to glass batch material based on a plurality of image data associated with a plurality of images of the of the mixture.

Clause 20. The computer program product of any of clauses 17-19, further causing the at least one processor to: determine a desired temperature of the mixture, wherein determining the desired temperature of the mixture comprises: receiving temperature data of the cullet; receiving temperature data of the glass batch material; and determining the desired temperature based on the temperature data of the cullet, the temperature data of the glass batch material, and a desired ratio of the cullet to glass batch material in the mixture.

Clause 21: The computer program product of any of clauses 17-20, wherein the action comprises: causing an increase in an amount of the cullet introduced into the mixture, causing a decrease in the amount of cullet introduced into the mixture, and causing no change in the amount of the cullet introduced into the mixture.

Clause 22: The computer program product of any of clauses 17-21, wherein causing the increase in the amount of cullet introduced is in response to determining that the ratio of cullet to glass batch material is less than a desired ratio of cullet to glass batch material, and wherein causing the decrease in the amount of cullet introduced is in response to determining that the ratio of cullet to glass batch material is more than the desired ratio of cullet to glass batch material.

Clause 23: The computer program product of any of clauses 17-22, wherein the action comprises causing a speed change of a conveyer, causing a change in operation of a mixing wheel, causing a change in a timing of introducing the cullet into the mixture, or causing a change in a rate of introducing of the cullet into the mixture.

Clause 24: The computer program product of any of clauses 17-23, wherein temperature of the cullet and temperature of the glass batch material differ.

Whereas particular embodiments of this invention have been described above for purposes of illustration, it will be evident to those skilled in the art that numerous variations of the details of the present invention may be made without departing from the invention as defined in the appended claims.

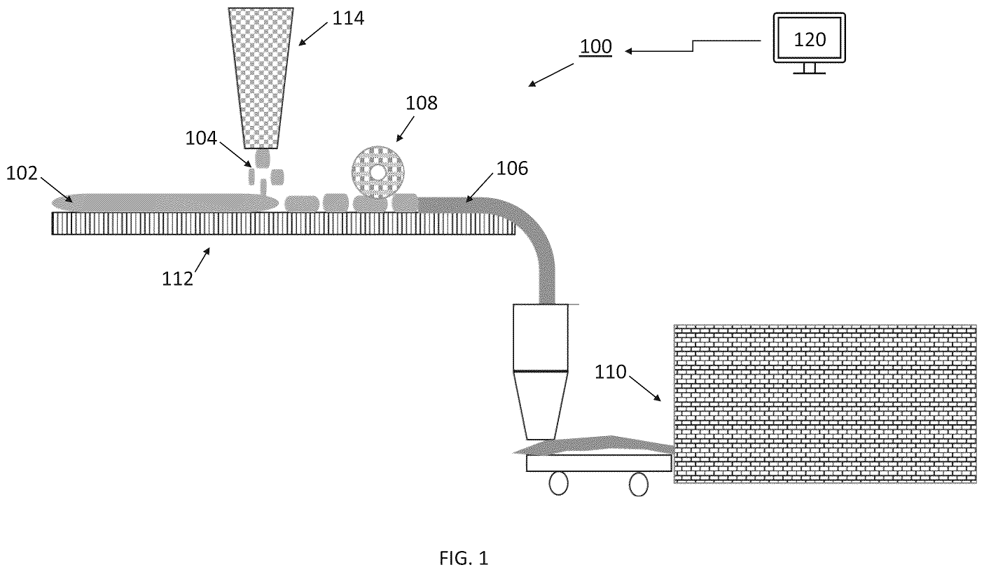

Referring to FIG. 1, a mixing system 100 for manufacturing a mixture 106 is shown according to some non-limiting embodiments or aspects. The mixing system 100 may include glass batch material 102. The glass batch material 102 may include: nepheline syenite, limestone, dolomite, soda ash, rouge, graphite, salt cake, alumina, or any other suitable material. The mixing system 100 may include cullet 104. The cullet 104 may include any suitable material for making glass. For example, cullet 104 may contain glass, recycled glass, material for making glass, etc. The glass batch material 102 may include a negligible amount or be essentially free of cullet 104. The mixing system 100 may include a mixture 106. The mixture 106 may include the glass batch material 102 and the cullet 104.

With continued reference to FIG. 1, the mixing system 100 may include a mixing wheel 108. The mixing wheel 108 may be configured to mix the glass batch material 102 and the cullet 104 to form the mixture 106. The mixing wheel 108 may be configured to evenly distribute the glass batch material 102 and the cullet 104 within the mixture 106. The conveyer 112 may transport the glass batch material 102 and the cullet 104 toward the mixing wheel 108. The conveyer 112 may transport the mixture 106 away from the mixing wheel 108. The mixing wheel 108 may be any other means for mixing the glass batch materials, such as but not limited to, any mixers such as horizontal ribbon mixer, paddle mixer, tumbler mixer, drum mixer, planetary mixer, agitators, etc. After the mixture 106 is formed, the conveyer 112 may transport the mixture 106 for further processing. For example, the conveyer 112 may transport the mixture 106 to a furnace 110 to form glass. The conveyer 112 may transport the mixture 106 back to the mixing system 100 for further mixing with additional glass batch material 102 and/or cullet 104.

With continued reference to FIG. 1, the mixing system 100 may include a conveyer 112. The conveyer 112 may transport the glass batch material 102, the cullet 104, and the mixture 106. The mixing system 100 may include more than one conveyers 112 that interconnect as to provide a continuous transport of the glass batch material 102, the cullet 104, and the mixture 106. For example, a different conveyer may be used to transport each of the glass batch material 102, an unmixed glass batch material 102 and cullet 104, and the mixture 106. In this manner, the speed of the transport for the glass batch material 102, the unmixed glass batch material 102 and cullet 104, and the mixture 106 may differ.

With continued reference to FIG. 1, the mixing system 100 may include a cullet container 114 that stores cullet 104. The cullet container 114 may be configured to introduce cullet 104 onto the conveyer 112 at a specific rate or by specific amounts. The mixing system 100 may include a glass batch material container (not shown) that stores the glass batch material 102. The glass batch material container may be configured to introduce the glass batch material 102 onto the conveyer 112 at a specific rate or by specific amounts.

With continued reference to FIG. 1, the mixing system 100 may include a control device 120. The control device 120 may be a user device, such as a mobile device, a computing device, etc. The control device 102 may control all aspects of the mixing system 100. For example, the control device 120 may be the user to input instructions that control the conveyer 112. The control device 120 may allow the user to cause the release of the glass batch material 102 and the cullet 104 to be introduced onto the conveyor 112. For example, the control device 120 may cause the glass batch material container and the cullet container 114 to introduce specific amounts of the glass batch material 102 and the cullet 104 or at a specific rate to release the glass batch material 102 or the cullet 104 onto the conveyer 112. The control device 120 may allow the user to cause the release of the glass batch material 102 and the cullet 104 at specified intervals to be introduced onto the conveyer 112. The control device 120 may allow the user to control the functionality of the mixing wheel 108, such as causing a change in speed and power of the mixing wheel 108. The control device 120 may be in communication with the conveyer 112, the mixing wheel 108, the glass batch material container, and/or the cullet container 114.

With continued reference to FIG. 1, the mixing system 100 may include one or more heat sensors (not shown). For example, the mixing system 100 may include one or more heat sensors to measure the temperature of the glass batch material 102 and the cullet 104. For example, the one or more heat sensors may measure the temperature of the glass batch material 102 and the cullet 104 before they are mixed to form the mixture 106. For example, the one or more heat sensors may measure the temperature of the glass batch material 102 and the cullet 104 in the glass batch material container or the cullet container 114. The one or more heat sensors may be any suitable sensor that detects heat, such as a temperature probe that is physically inserted into the glass batch material 102 and the cullet 104 before they are mixed. The one or more heat sensors may be in communication with the control device 120.

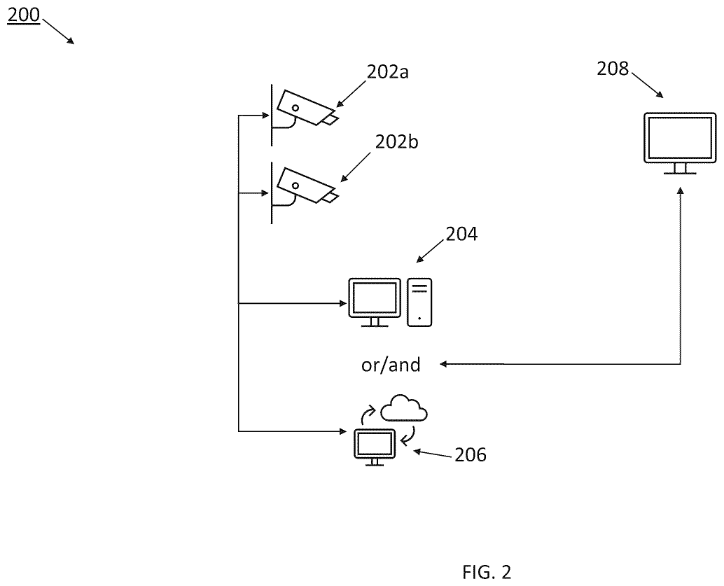

Referring to FIG. 2, a system 200 for determining a quality of a mixture is shown according to some non-limiting embodiments or aspects. For example, the system 200 may determine a ratio of cullet 104 to glass batch material 102 in the mixture 106. The system 200 may include one or more cameras 202, a computing device 204, a server 206, and a user interface 208. The computing device 204 and the server 206 may be interchangeable. The computing device 204 and/or the server 206 may be configured to communicate with the camera 202 and the user interface 208. The computing device 204 and/or the server 206 may be configured to communicate with the mixing system 100. For example, the computing device 204 and/or the server 206 may be configured to communicate with the control device 120, the conveyer 112, the mixing wheel 108, the glass batch material container, and/or the cullet container 114. The system 200 may include one or more computing devices 204 and/or one or more servers 206.

With continued reference to FIG. 2, the system 200 may include one or more cameras 202. For example, the system 200 may have two cameras 202a and 202b, as shown in FIG. 2. It is appreciated that the mixture monitoring system 200 may include any number of cameras 202. In some non-limiting embodiments or aspects, the one or more cameras 202 may be an IR camera or a visible light camera. For example, the camera 202 may be an IR camera, which is capable of capturing infrared radiation or IR data. The camera 202 may capture IR in the form of an image data or the captured IR data may be transformed into an IR image data. The IR camera may be capable of capturing, storing, and transmitting the IR image data. Additionally or alternatively, the camera 202 may be a visible light camera, which captures visible light radiation. The camera 202 may capture visible light in the form of an image data or the visible light data may be transformed into an image data. The visible light camera may be capable of capturing, storing, and transmitting visible light image data. The camera 202 may be configured to continuously capture, transform, store, and/or transmit image data. The frequency of capture, transmission, and/or storage of captured data by the camera 202 may be varied and determined by a user. A user may input instructions to change the frequency into the user interface 208. For example, the inputted instructions may cause the camera to capture, store, transmit, and/or transform captured data once every second, minute, etc. Additionally or alternatively, the frequency may be determined based on the speed of the conveyer 112. For example, the frequency may be determined such that no overlapping portions of the mixture 106 is captured among a plurality of image data, or the frequency may be determined such that multiple more than one overlapping portions of the mixture 106 are captured among a plurality of image data. The camera 202 may be placed anywhere within the mixing system 100, such that the camera 202 can suitably capture IR and/or visible light data of the mixture 106. For example, the camera 202 may be positioned such that image data of the mixture 106 past the mixing wheel 108 is obtained.

With continued reference to FIG. 2, the system 200 may include one or more computing devices 204 and/or one or more servers 206. The one or more servers may be a physical server or a virtual server, such as a cloud. The computing device 204 and/or the server 206 may be in wired or wireless communication with the mixing system 100 and the system 200. For example, the computing device 204 and/or the server 206 may be in communication with the control device 120, the conveyer 112, the glass batch material container, the cullet container 114, the mixing wheel 108, the camera 202, and the user interface 208. The computing device 204 and/or the server 206 may receive and transmit communications to any components of the mixing system 100 and the system 200. The computing device 204 and/or the server 206 may be in communication with the user interface 208. In some non-limiting embodiments or aspects, the computer device 204 and/or the server 206 may be configured to transform the light data captured by the camera 202 into image data.

With continued reference to FIG. 2, the system 200 may include a user interface 208. The system 200 may include one or more user interfaces 208. In some non-limiting embodiments or aspects, the user interface 208 may be the control device 120. Additionally or alternatively, the user interface 208 may be in wired or wireless communication with the control device 120. The user interface 208 may be a cellular phone, a tablet, a computer, etc. The user interface 208 may allow a user to control the operational functions of any of the components of the mixing system 100 and the system 200 by transmitting instructions, which are inputted by the user, to the computing system 204 and/or the server 206. The user interface 208 may be configured to display information that is received, transformed, transmitted, and/or stored by the computing device 204 and/or the server 206. For example, the user interface 208 may display image data, temperature of the glass batch material 102 and cullet 104, ratio of the glass batch material 102 and cullet 104, speed and power of the mixing wheel 108, speed of the conveyer 112, the rate at which the glass batch material 102 and the cullet 104 are introduced onto the conveyer 112, etc. The user interface 208 may be configured to transmit instructions in response to receiving instructions from the user to the computing device 204 and/or the server 206. The computing device 204 and/or the server 206 may then cause a component of the mixing system 100 or the system 200 to execute the instructions. For example, the received instructions may cause a component of mixing system 100 and/or the system 200 to change quantity and speed of the glass batch material 102 and cullet 104 introduced onto the conveyer belt 112, the speed of the conveyer belt 112, the power and speed of the mixing wheel 108, etc.

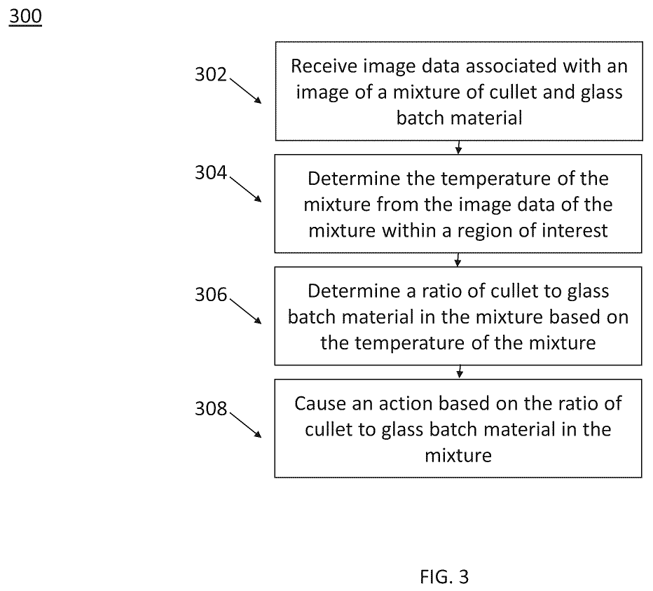

Referring to FIG. 3, shown is a flow diagram for a process 300 of determining ratio of cullet 104 to glass batch 102 material. The steps shown in FIG. 3 are for example purposes only. It will be appreciated that additional, fewer, different, and/or different order of steps may be used in non-limiting embodiments or aspects. In some non-limiting embodiments or aspects, a step may be automatically performed in response to performance and/or completion of a prior step. In some non-limiting embodiments or aspects, one or more steps of process 300 may be performed (e.g., completely, partially, and/or the like) by the computing device 204 and/or the server 206. In some non-limiting embodiments or aspects, one or more steps of process 300 may be performed (e.g., completely, partially, and/or the like) by another system, another device, another group of systems, or another group of devices, separate from or including the computing device 204 and/or the server, such as user interface 208, the one or more cameras 202, the control device, and/or the like.

As shown in FIG. 3, at step 302, the process 300 may include receiving an image data associated with an image of a mixture 106 of a cullet 104 and glass batch material 102. For example, the computing device 204 and/or the server may 206 receive the image data associated with the image of the mixture 106 of the cullet 104 and glass batch material 102. The image data associated with the image of the mixture 106 of the cullet 104 and batch material 102 may be transmitted from the camera 202 to the computing device 204 and/or the server 206.

In some non-limiting embodiments or aspects, a region of interest may be determined. For example, the computing device 204 and/or the server 206 may determine a region of interest determined based on the image data associated with the image of the mixture 106 of the cullet 104 and glass batch material 102. In some non-limiting embodiments or aspects, the region of interest may include an area of the mixture 106 in the image data. in some non-limiting embodiments or aspects, the region of interest may be determined based image data based on visible-light image captured from a visible light camera 202, image data based on IR image captured from an IR camera 202, or combinations thereof. In some non-limiting embodiments or aspects, the region of interest in the image data may only include the mixture 106 in the image data, such that other light data obtained in the image data from sources other than the mixture 106 is excluded. The region of interest may change as the mixture 106 continuously passes the camera 202 on the conveyer 112 in different quantities or shape. Alternatively, the region of interest may be manually determined by a user. For example, the region of interest may be a section of the conveyer 112 in the image data, in which the mixture 106 is constantly present as the mixture 106 passes the camera 202 on the conveyer 112.

As shown in FIG. 3, at step 304, the process 300 may include determining the temperature of the mixture 106 from the image data of the mixture 106 within a region of interest. For example, the computing device 204 and/or the server 206 may determine the temperature of the mixture 106 from the image data of the mixture 106 within a region of interest. In some non-limiting embodiments or aspects, the temperature of the mixture 106 may be determined in response to determining the region of interest. For example, a real-time temperature of the mixture 106 may be determined from an image data of the mixture 106 within the region of interest. In some non-limiting embodiments or aspects, the temperature of the mixture 106 may be determined from IR image data associated with an image of the mixture 106. In some non-limiting embodiments or aspects, an average temperature of the mixture 106 may be determined based on a plurality of image data associated with a plurality of images of the mixture 106.

As shown in FIG. 3, at step 306, the process 300 may include determining a ratio of cullet 104 to glass batch material 102 in the mixture 106 based on the temperature of the mixture 106. For example, the computing device 204 and/or the server 206 may determine a ratio of cullet 104 to glass batch material 102 in the mixture 106 based on the temperature of the mixture 106. The ratio of the mixture 106 may be determined based on the temperature of the mixture 106, the temperature of the glass batch material 102, and the temperature of the cullet 104. The temperatures of the glass batch material 102 and the temperature of the cullet 104 may differ. The temperatures of the glass batch material 102 and the temperature of the cullet 104 may be transmitted to the computing device 204 and/or the server 206 by one or more heat sensors placed in vicinity of within the glass batch material 102 and the cullet 104. An average temperature of the mixture 106 may be determined based on a plurality temperature determinations of the mixture 106. The average temperature may be determined based on temperature of the mixture 106 determined during any set time periods, such as 1 second, 10 seconds, 1 minute, 10 minutes, the entire duration, etc. of operation of the mixing system 100 and/or the system 200. Additionally or alternatively, the temperature of the mixture 106 may be determined at any given frequency determined by a user, such as every 1 second, 10 seconds, 1 minute, etc.

In some non-limiting embodiments or aspects, a desired temperature of the mixture 106 may be determined. For example, the computing device 204 and/or the server 206 may determine a desired temperature of the mixture 106. To determine the desired temperature of the mixture 106, temperature data of the cullet 104 and the temperature data of the glass batch material 102 may be received. For example, the one or more heat sensors placed within or in vicinity of the glass batch material 102 and the cullet 104 may transmit the temperature data or temperature of the glass batch material 102 and the cullet 104 to the computing device 204 and/or the server 206. Based on the received temperature data of the cullet 104, temperature data of the glass batch material 102, and a desired ratio of the cullet 104 to glass batch material 102, the desired temperature of the mixture 106 may be determined. The desired temperature of the mixture 106 may continuously be determined and fluctuate as the temperature of the cullet 104 and/or the temperature of the glass batch material 102 change.

As shown in FIG. 3, at step 308, the process 300 may include causing an action based on the ratio of cullet 104 to glass batch material 102 in the mixture 106. For example, the computing device 204 and/or the server 206 may cause an action based on the ratio of cullet 104 to glass batch material 102 in the mixture 106. In some non-limiting embodiments or aspects, the action may include causing an increase in an amount of the cullet 104 introduced into the mixture 106, causing a decrease in the amount of cullet 104 introduced into the mixture 106, and causing no change in the amount of the cullet 104 introduced into the mixture 106. Causing the increase in the amount of cullet 104 introduced may be in response to determining that the ratio of cullet 104 to glass batch material 102 is less than the desired ratio of cullet 104 to glass batch material 102. Causing the decrease in the amount of cullet 104 introduced may be in response to determining that the ratio of cullet 104 to glass batch material 102 is more than the desired ratio of cullet 104 to glass batch material 102.

In some non-limiting embodiments or aspects, the action may include causing a speed change of a conveyer 112. For example, the computing device 204 and/or the server 206 may cause a speed change of a conveyer 112. In some non-limiting embodiments or aspects, the action may include increasing or decreasing the speed of the conveyer 112, at which the conveyer 112 carries the glass batch material 102, unmixed glass batch material 102 and cullet 104, and/or the mixture 106 are transported. For example, the speed of the conveyer 112 transporting glass batch material 102 may be increased to decrease the ratio of cullet 104 to glass batch material 102 without changing the rate or amount of cullet 104 introduced into the mixture 106. The speed of the conveyer 112 may be increased in response to determining that the ratio of cullet 104 to glass batch material 102 is higher than the desired ratio of cullet 104 to glass batch material 102. Additionally or alternatively, the speed of the conveyer 112 transporting glass batch material 102 may be decreased to increase the ratio of cullet 104 to glass batch material 102 without changing the rate or amount of cullet 104 introduced into the mixture 106. The speed of the conveyer 112 may be decreased in response to determining that the ratio of cullet 104 to glass batch material 102 is lower than the desired ratio of cullet 104 to glass batch material 102.

In some non-limiting embodiments or aspects, the action may include causing a change in operation of a mixing wheel 108. For example, the computing device 204 and/or the server 206 may cause a change in operation of a mixing wheel 108. In some non-limiting embodiments or aspects, the mixing wheel 108 may be caused to mix the cullet 104 and the glass batch material 102 for additional time. The mixing wheel 108 may be caused to operate for additional time in response to determining that the temperature of the mixture 106 is inconsistent. For example, it may be determined that the glass batch material 102 and the cullet 104 are not mixed thoroughly based on a plurality of temperature measurements of the mixture 106. For example, it may be determined that the batch material 102 and the cullet 104 are not mixed thoroughly if discrepancies between the temperature measurements of the mixture 106 are above a certain threshold. Additionally or alternatively, the mixing wheel 108 may be caused to operate for less time in response to determining that the temperature of the mixture 106 is consistent to conserve energy and time for generating mixture 106. For example, it may be determined that the batch material 102 and the cullet 104 are mixed thoroughly if discrepancies between the temperature measurements of the mixture 106 are below a certain threshold. The action may include causing a change in operation of the cullet container 114. For example, the computing device 204 and/or the server 206 may cause the cullet container 114 to release the cullet 104 onto the conveyer 112 in a different timing or amount. For example, the interval at which the cullet 104 is released onto the conveyer 112 from the cullet container 114 may be increased or decreased. The rate at which the cullet 104 is released onto the conveyer 112 from the cullet container 114 may be increased or decreased.

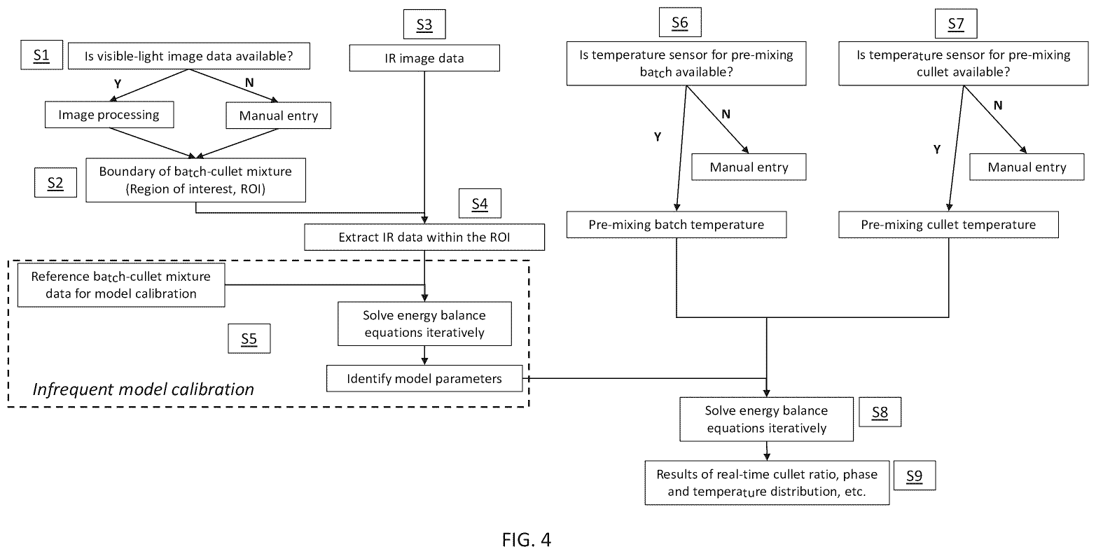

Referring to FIG. 4, shown is a step diagram for determining a ratio of the cullet 104 to the glass batch material 102 of the mixture 106 according to some non-limiting embodiments or aspects. At step S1, whether visible-light image data may available is determined. It may also be determined whether IR image data is available. The determination may be made based on the visible-light image data received from a visible-light camera 202, an IR camera, or combinations thereof. The computing device 204 and/or the server 206 may receive the visible-light image data, IR light image data, or combinations thereof from the one or more cameras 202. It may be determined that the visible-light image data, IR image data, or combinations thereof is available if the computing device 204 and/or the server 206 identifies the mixture 106 in the image data on the conveyer 112.

At step S2, the boundary of batch-cullet mixture 106 may be determined. The boundary of the mixture 106 may be determined in response to determining that the mixture 106 is visible in the image data in step S1. The boundary may be the region of interest in the image data. The boundary may be determined by the computing device 204 and/or the server 206. If visible-light image data is not available, a user may manually define the boundary of the cullet-glass batch material mixture 106. The user may manually define the boundary by defining the boundary via the user interface 208. Additionally or alternatively, the boundary may be determined by the computing device 204 and/or the server based on IR image data received from the one or more cameras 202.

At step S3, IR image data may be received. For example, the IR image data may be transmitted from the camera 202 to the computing device 204 and/or the server 206. At step S4, IR data may be extracted from the IR image data within the defined boundary or the region of interest.

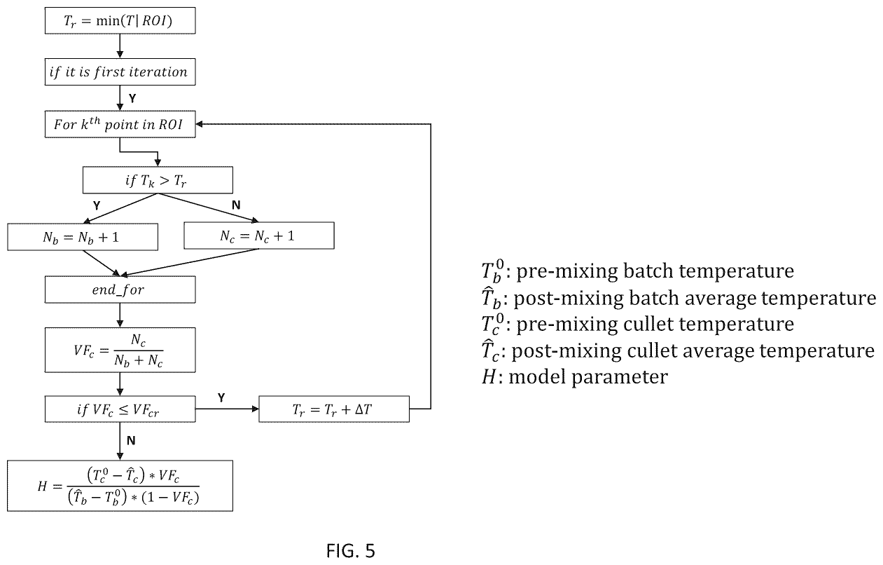

At step S5, the extracted IR data may be used to calibrate a model, as shown in FIG. 5.

At step S6, whether temperature sensor for the glass batch material 102 before being formed into the mixture 106 is available is determined. The temperature sensor may be the one or more heat sensors discussed above. If it is determined that the temperature sensor is not available, a user may manually enter the temperature of the glass batch material 102 into the computing device 204 and/or the server 206 via the user interface 208. The system if temperature sensor for the glass batch material 102 is available, the temperature sensor may obtain and transmit the temperature data of the glass batch material 102 to the computing device 204 and/or the server 206.

At step S7, whether the temperature sensor for cullet 104 before being formed into the mixture 106 is available is determined. The temperature sensor may be the one or more heat sensors discussed above. If it is determined that the temperature sensor is not available, a user may manually enter the temperature of the cullet 104 into the computing device 204 and/or the server 206 via the user interface 208. If the temperature sensor for the cullet 104 is available, the temperature sensor may obtain and transmit temperature data of the cullet 104 to the computing device 204 and/or the server 206.

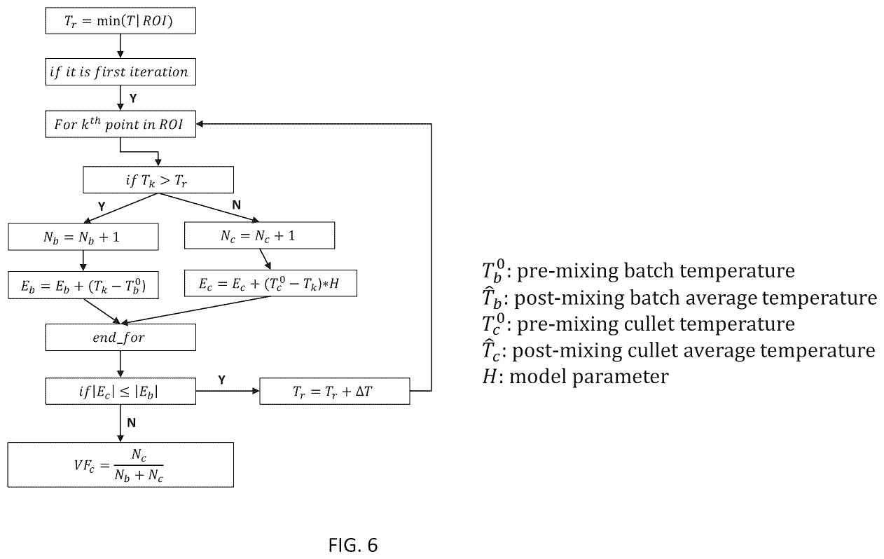

At step S8, the energy balance equation may be solved iteratively. The energy balance equation may be solved according to the model, as shown in FIG. 6, in real-time. The model may have been calibrated in step S5.

At step S9, results of real-time cullet 104 to glass batch material 102 ratio, phase, temperature distribution, etc. may be determined.

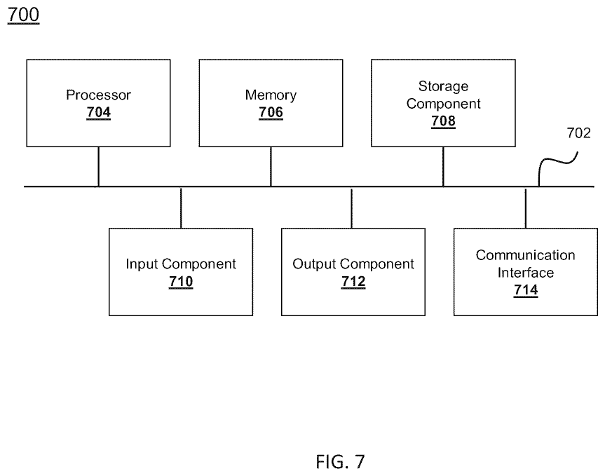

Referring to FIG. 7, a diagram is shown of example components of device 700. Device 700 may correspond to one or more devices or systems described herein, such as the mixing system 100, the conveyer 112, the control device 120, the mixing wheel 108, the system 200, the camera 202, the computing device 204, the server 206, and/or the user interface 208. In some non-limiting embodiments, one or more devices or systems described herein may include at least one device 700 and/or at least one component of device 700. As shown in FIG. 7, device 700 may include bus 702, processor 704, memory 706, storage component 708, input component 710, output component 712, and communication interface 714.

Bus 702 may include a component that permits communication among the components of device 700. In some non-limiting embodiments, processor 704 may be implemented in hardware, software, or a combination of hardware and software. For example, processor 704 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 706 may include random access memory (RAM), read-only memory (ROM), and/or another type of dynamic or static storage device (e.g., flash memory, magnetic memory, optical memory, etc.) that stores information and/or instructions for use by processor 704.

Storage component 708 may store information and/or software related to the operation and use of device 700. For example, storage component 708 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 710 may include a component that permits device 700 to receive information, such as via user input (e.g., a touchscreen display, a keyboard, a keypad, a mouse, a button, a switch, a microphone, a camera, etc.). Additionally or alternatively, input component 710 may include a sensor for sensing information (e.g., a global positioning system (GPS) component, an accelerometer, a gyroscope, an actuator, etc.). Output component 712 may include a component that provides output information from device 700 (e.g., a display, a speaker, one or more light-emitting diodes (LEDs), etc.).

Communication interface 714 may include a transceiver-like component (e.g., a transceiver, a separate receiver and transmitter, etc.) that enables device 700 to communicate with other devices, such as via a wired connection, a wireless connection, or a combination of wired and wireless connections. Communication interface 714 may permit device 700 to receive information from another device and/or provide information to another device. For example, communication interface 714 may include an Ethernet interface, an optical interface, a coaxial interface, an infrared interface, a radio frequency (RF) interface, a universal serial bus (USB) interface, a Wi-Fi® interface, a Bluetooth® interface, a Zigbee® interface, a cellular network interface, and/or the like.

Device 700 may perform one or more processes described herein. Device 700 may perform these processes based on processor 704 executing software instructions stored by a computer-readable medium, such as memory 706 and/or storage component 708. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 706 and/or storage component 708 from another computer-readable medium or from another device via communication interface 714. When executed, software instructions stored in memory 706 and/or storage component 708 may cause processor 704 to perform one or more processes described herein. Additionally or alternatively, hardwired circuitry may be used in place of or in combination with software instructions to perform one or more processes described herein. Thus, embodiments described herein are not limited to any specific combination of hardware circuitry and software.

Memory 706 and/or storage component 708 may include data storage or one or more data structures (e.g., a database, and/or the like). Device 700 may be capable of receiving information from, storing information in, communicating information to, or searching information stored in the data storage or one or more data structures in memory 706 and/or storage component 708. For example, the information may include input data, output data, transaction data, account data, or any combination thereof.

Whereas particular embodiments of this invention have been described above for purpose of illustration, it will be evident to those skilled in the art that numerous variations of the details of the present invention may be made without departing from the invention as defined in the appended claims.

What is claimed is:

1. A computer-implemented method of determining a ratio of components within a mixture, comprising:
receiving with at least one processor image data associated with an image of a mixture of cullet and glass batch material;
determining with at least one processor the temperature of the mixture from the image data of the mixture within a region of interest;
determining with at least one processor a ratio of cullet to glass batch material in the mixture based on the temperature of the mixture; and
causing with at least one processor an action based on the ratio of cullet to glass batch material in the mixture.

2. The computer implemented method of claim 1, further comprising determining the region of interest within the image data, wherein the region of interest comprises an area of the mixture in the image data.

3. The computer implemented method of claim 1, further comprising determining an average ratio of cullet to glass batch material based on a plurality of image data associated with a plurality of images of the of the mixture.

4. The computer implemented method of claim 1, further comprising determining a desired temperature of the mixture, wherein determining the desired temperature of the mixture comprises:
receiving temperature data of the cullet;
receiving temperature data of the glass batch material; and
determining the desired temperature based on the temperature data of the cullet, the temperature data of the glass batch material, and a desired ratio of the cullet to glass batch material in the mixture.

5. The computer implemented method of claim 1, wherein the action comprises causing an increase in an amount of the cullet introduced into the mixture, causing a decrease in the amount of cullet introduced into the mixture, and causing no change in the amount of the cullet introduced into the mixture.

6. The computer implemented method of claim 5, wherein causing the increase in the amount of cullet introduced is in response to determining that the ratio of cullet to glass batch material is less than a desired ratio of cullet to glass batch material, and wherein causing the decrease in the amount of cullet introduced is in response to determining that the ratio of cullet to glass batch material is more than the desired ratio of cullet to glass batch material.

7. The computer implemented method of claim 1, wherein the action comprises causing a speed change of a conveyer, causing a change in operation of a mixing wheel, causing a change in a timing of introducing the cullet into the mixture, or causing a change in a rate of introducing of the cullet into the mixture.

8. The computer implemented method of claim 1, wherein temperature of the cullet and temperature of the glass batch material differ.

9. A system comprising at least one processor programmed or configured to:
receiving image data associated with an image of a mixture of cullet and glass batch material;
determine the temperature of the mixture from the image data of the mixture within a region of interest;
determine a ratio of cullet to glass batch material in the mixture based on the temperature of the mixture; and
cause an action based on the ratio of cullet to glass batch material in the mixture.

10. The system of claim 9, the at least one processor further programmed or configured to determine the region of interest within the image data, wherein the region of interest comprises an area of the mixture in the image data.

11. The system of claim 9, the at least one processor further programmed or configured to determine an average ratio of cullet to glass batch material based on a plurality of image data associated with a plurality of images of the of the mixture.

12. The system of claim 9, the at least one processor further programmed or configured to:
determine a desired temperature of the mixture, wherein determining the desired temperature of the mixture comprises:
receiving temperature data of the cullet;
receiving temperature data of the glass batch material; and
determining the desired temperature based on the temperature data of the cullet, the temperature data of the glass batch material, and a desired ratio of the cullet to glass batch material in the mixture.

13. The system of claim 9, wherein the action comprises causing an increase in an amount of the cullet introduced into the mixture, causing a decrease in the amount of cullet introduced into the mixture, and causing no change in the amount of the cullet introduced into the mixture.

14. The system of claim 13, wherein causing the increase in the amount of cullet introduced is in response to determining that the ratio of cullet to glass batch material is less than a desired ratio of cullet to glass batch material, and wherein causing the decrease in the amount of cullet introduced is in response to determining that the ratio of cullet to glass batch material is more than the desired ratio of cullet to glass batch material.

15. The system of claim 9, wherein the action comprises causing a speed change of a conveyer, causing a change in operation of a mixing wheel, causing a change in a timing of introducing the cullet into the mixture, or causing a change in a rate of introducing of the cullet into the mixture.

16. The system of claim 9, wherein temperature of the cullet and temperature of the glass batch material differ.

17. A computer program product comprising at least one non-transitory computer-readable medium including program instructions that, when executed by at least one processor, cause the at least one processor to:
receiving image data associated with an image of a mixture of cullet and glass batch material;
determine the temperature of the mixture from the image data of the mixture within a region of interest;
determine a ratio of cullet to glass batch material in the mixture based on the temperature of the mixture; and
cause an action based on the ratio of cullet to glass batch material in the mixture.

18. The computer program product of claim 17, further causing the at least one processor to determine the region of interest within the image data, wherein the region of interest comprises an area of the mixture in the image data.

19. The computer program product of claim 17, further causing the at least one processor to determine an average ratio of cullet to glass batch material based on a plurality of image data associated with a plurality of images of the of the mixture.

20. The computer program product of claim 17, further causing the at least one processor to:
determine a desired temperature of the mixture, wherein determining the desired temperature of the mixture comprises:
receiving temperature data of the cullet;
receiving temperature data of the glass batch material; and
determining the desired temperature based on the temperature data of the cullet, the temperature data of the glass batch material, and a desired ratio of the cullet to glass batch material in the mixture.

21. The computer program product of claim 17, wherein the action comprises causing an increase in an amount of the cullet introduced into the mixture, causing a decrease in the amount of cullet introduced into the mixture, and causing no change in the amount of the cullet introduced into the mixture.

22. The computer program product of claim 21, wherein causing the increase in the amount of cullet introduced is in response to determining that the ratio of cullet to glass batch material is less than a desired ratio of cullet to glass batch material, and wherein causing the decrease in the amount of cullet introduced is in response to determining that the ratio of cullet to glass batch material is more than the desired ratio of cullet to glass batch material.

23. The computer program product of claim 17, wherein the action comprises causing a speed change of a conveyer, causing a change in operation of a mixing wheel, causing a change in a timing of introducing the cullet into the mixture, or causing a change in a rate of introducing of the cullet into the mixture.

24. The computer program product of claim 17, wherein temperature of the cullet and temperature of the glass batch material differ.
